(19) United States
(12) Patent Application Publication
(10) Pub. No.: US 2016/0175825 A1
(43) Pub. Date: Jun. 23, 2016

(54) PROCESS FOR CATALYST REDUCTION

(71) Applicant: UOP LLC, Des Plaines, IL (US)

(72) Inventors: Pelin Cox, Des Plaines, IL (US); Deng-Yang Jan, Elk Grove Village, IL (US)

(21) Appl. No.: 14/574,288

(22) Filed: Dec. 17, 2014

(51) Int. Cl. B01J 29/90; B01J 38/04

(52) U.S. Cl. CPC B01J 29/90; B01J 38/04

(57) ABSTRACT

A process is disclosed for an improved catalyst reduction process. The reduction zone is divided into two zones. The first reduction zone is a drying zone where a substantial portion of the chemisorbed water is removed at lower severity conditions. After the catalyst is partially dried, the partially dried catalyst moves to the second reduction zone to be reduced and further dried at higher severity conditions. The flow rate and the reduction zone are designed to ensure there is minimal water left on the catalyst by the time it leaves the reduction zone. This design eliminates high levels of H₂O at high severity conditions in both the reduction zone and the reactors.

### FIELD

The present subject matter relates generally to methods for hydrocarbon conversion. More specifically, the present subject matter relates to methods for drying and reducing a catalyst for reuse in the hydrocarbon conversion process.

### BACKGROUND

Hydrocarbons, and in particular petroleum, are produced from the ground as a mixture. This mixture is converted to useful products through separation and processing of the streams in reactors. The conversion of the hydrocarbon streams to useful products is often through a catalytic process in a reactor. The catalysts can be solid or liquid, and can comprise catalytic materials. In bi-functional catalysis, catalytic materials of acid such as zeolite and metals such as those in transition and main groups are combined to form a composite to facilitate the conversion process such as the one described in this subject application.

Hydrocarbon processes such as dehycrocyclodimeraization utilize a catalyst made up of zeolitic material and hydrothermal de-alumination accounts for the majority of catalyst deactivation over the life of the commercial operation cycle. The propensity of zeolitic materials to dealuminate increases as water concentration and temperature increase. Hydrothermal damage to the molecular sieve components of catalysts can significantly shorten catalyst stability and overall life cycle. Sources of water include desorption of water on the catalyst coming from the regeneration section in addition to the water generated in the reduction zone through the reduction of the catalyst. Preferred level of reduction necessitates high severity temperatures which inevitably desorbs a substantial amount of chemisorbed water contributing to hydrothermal damage of the catalyst. In addition, any remaining chemiadsorbed water from incomplete drying will desorb in the reactors where the catalyst spends a significant amount of residence time at elevated temperatures. Both the reduction zone and the reactors contribute to hydrothermal dealumination since both zones may have high partial pressure of water and temperature. Improvement of the reduction zone design can significantly reduce hydrothermal damage in both the reduction zone and the reactors.

### SUMMARY

The present subject matter provides an improved catalyst reduction process. The reduction zone is divided into two zones. The first reduction zone is a drying zone where a substantial portion of the chemisorbed water is removed at lower severity conditions. After the catalyst is partially dried, the partially dried catalyst moves to the second reduction zone to be reduced and further dried at higher severity conditions. The flow rate and the reduction zone are designed to ensure there is minimal water left on the catalyst by the time it leaves the reduction zone. This design eliminates high levels of H₂O at high severity conditions in both the reduction zone and the reactors.

In the first reduction zone, a first drying gas is passed into the first reduction zone and flows over the regenerated catalyst to remove a substantial portion of chemisorbed water. The first drying gas is heated to a temperature between 280° C. and 550° C. before passing into the first reduction zone. The first drying gas is distributed around the first reduction zone and flows through the catalyst passing down through the first reduction zone. The second reduction gas is heated to a temperature between 400° C. and 650° C. before passing into the second reduction zone. The second reduction gas flows up through the second reduction zone and flows counter currently against the catalyst before exiting the second reduction zone. The dried and reduced catalyst is withdrawn through the catalyst outlet at the bottom of the reduction zone.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### DEFINITIONS

As used herein, the term “dehydrocyclodimerization” is also referred to as aromatization of light paraffins. Within the subject disclosure, dehydrocyclodimerization and aromatization of light hydrocarbons are used interchangeably.

As used herein, the term “stream”, “feed”, “product”, “part” or “portion” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C₁, C₂, C₃, Cn where “n” represents the number of carbon atoms in the one or more hydrocarbon molecules or the abbreviation may be used as an adjective for, e.g., non-aromatics or compounds. Similarly, aromatic compounds may be abbreviated A₆, A₇, A₈, An where “n” represents the number of carbon atoms in the one or more aromatic molecules. Furthermore, a superscript “+” or “−” may be used with an abbreviated one or more hydrocarbons notation, e.g., C₃₊ or C₃₋, which is inclusive of the abbreviated one or more hydrocarbons. As an example, the abbreviation “C₃₊” means one or more hydrocarbon molecules of three or more carbon atoms.

As used herein, the term “zone” can refer to an area including one or more equipment items and/or one or more sub-zones. Equipment items can include, but are not limited to, one or more reactors or reactor vessels, separation vessels, distillation towers, heaters, exchangers, pipes, pumps, compressors, and controllers. Additionally, an equipment item, such as a reactor, dryer, or vessel, can further include one or more zones or sub-zones.

As used herein, the term “active metal” can include metals selected from IUPAC Groups that include 6,7, 8, 9, 10,13 and mixtures of thereof. The IUPAC Group 6 trough 10 includes without limitation chromium, molybdenum, tungsten, rhenium, platinum, palladium, rhodium, iridium, ruthenium, osmium, zinc, copper, and silver. The IUPAC Group 13 includes without limitation gallium and indium.

As used herein, the term “modifier metal” can include metals selected from IUPAC Groups 11-17. The IUPAC Group 11 trough 17 includes without limitation sulfur, gold, tin, germanium, and lead.

As used herein, the term “thermal mass ratio” (TMR) is defined as the ratio of the gas flow rate to the catalyst circulation rate.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic depiction of a reduction zone having multiple zones for drying and reduction of catalyst flowing through the reduction zone.

### DETAILED DESCRIPTION

The following detailed description is merely exemplary in nature and is not intended to limit the application and uses of the embodiment described. Furthermore, there is no intention to be bound by any theory presented in the preceding background or the following detailed description.

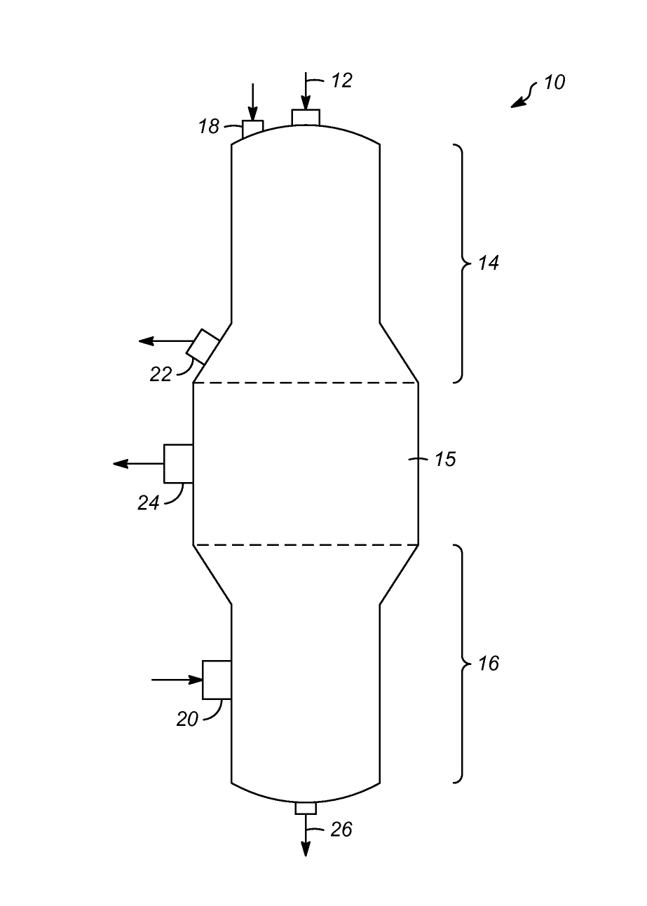

FIG. 1 illustrates a flow diagram of various embodiments of the processes described herein. Those skilled in the art will recognize that this process flow diagram has been simplified by the elimination of many pieces of process equipment including for example, heat exchangers, process control systems, pumps, fractionation column overhead, reboiler systems and reactor internals, etc. which are not necessary to an understanding of the process. It may also be readily discerned that the process flow presented in the drawing may be modified in many aspects without departing from the basic overall concept. For example, the depiction of required heat exchangers in the drawing have been held to a minimum for purposes of simplicity. Those skilled in the art will recognize that the choice of heat exchange methods employed to obtain the necessary heating and cooling at various points within the process is subject to a large amount of variation as to how it is performed. In a process as complex as this, there exists many possibilities for indirect heat exchange between different process streams. Depending on the specific location and circumstance of the installation of the subject process, it may also be desired to employ heat exchange against steam, hot oil, or process streams from other processing units not shown on the drawing.

With reference to FIG. 1, a system and process in accordance with various embodiments includes a reduction zone 10. A stream of regenerated catalyst particles 12 is continuously introduced to the reduction zone 10. Although the term continuous is applied to this process herein, the process may include a continuous, semi-continuous, or batch process where small amounts of catalyst are withdrawn from the regenerator and passed to the reduction zone on a relatively continuous basis. The catalyst particles flow downward through the reduction zone 10. The reduction zone 10 is divided into an upper reduction zone 14 and a lower reduction zone 16. The upper reduction zone 14 is a drying zone and is separated from the lower reduction zone 16 by an intermediate portion 15. The intermediate portion 15 allows for the separation of the upper reduction zone 14 and the lower reduction zone 16. As catalyst particles 12 flow down through the upper reduction zone 14, a first drying gas enters through the upper reduction zone inlet 18 and contacts the catalyst particles 12 to reduce the water on the catalyst particles. Preferably, the first drying gas stream has only enough moisture that is required to reduce the chemisorbed H₂Oon the catalyst by at least 25 wt % before entering the first reduction zone 14. The catalyst particles 12 flow down through the upper reduction zone 14 to provide sufficient time for the catalyst to be dried. The catalyst contacts the first drying gas co-currently. However, it is also contemplated that the catalyst may contact the first drying gas counter-currently as well. The catalyst will have an average residence time in the upper reduction zone between 0.5 and 3 hours, with a preferred time between 1 and 2 hours. In the example illustrated in FIG. 1, at least about 25 wt % of the totally chemisorbed water on the catalyst is removed in the first reduction zone.

The first drying gas is cycled through a upper drying zone 14 using a first blower for circulation of the drying gas. The first drying gas may also be cycled using a compressor. The first drying gas may include hydrogen. However, it is also contemplated that the drying gas may include N₂, Ar, He, C₁, C₂, C₃, CO₂, or air. The first drying gas is heated to a drying temperature before passing to the upper reduction zone as the first drying gas stream. The first drying gas exits the reduction zone 10 through the upper reduction zone outlet 22. The upper reduction zone temperature is between 280° C. and 550° C., with a preferable temperature between 300° C. and 450° C. The pressure for the first reduction zone is between 2 psig to 50 psig and thermal mass ratio of the first drying gas stream is between 0.8 and 5.

In the example shown in FIG. 1, the first drying gas stream flows co-currently to the catalyst to contact the catalyst. However, it is also contemplated that the first drying gas stream may flow counter-currently to the catalyst. The catalyst flows downward from the upper reduction zone 14 using gravity. Therefore in the example where the catalyst and the first drying stream flow co-currently, the first drying gas must enter the first gas stream inlet 18 and exit the first gas stream outlet 22. However, in the example where the catalyst and the first drying stream flow counter-currently, the first gas stream may enter at opening 22 and exit at opening 18.

FIG. 1 illustrates an intermediate zone 15. However, it is also contemplated that there may be no intermediate zone 15 and the upper reduction zone 14 may be in direct contact with the lower reduction zone 16. Therefore, catalyst may flow directly from the upper reduction zone 14 to the lower reduction zone 16.

An advantage of the catalyst reduction process is that drying and reduction of the catalyst in two or more separate zones can effectively remove the water with minimal hydrothermal damage, while keeping the reduction zone size minimal The present subject matter includes a lower reduction zone 16 where a separate reduction gas is used to complete the reduction process and to further reduce the chemisorbed water on the catalyst.

The catalyst is further processed and flows from the upper reduction zone 14 to the lower reduction zone 16, where the catalyst is contacted with a second reduction gas stream for reducing the catalyst and further drying the residual water. The second reduction gas enters through the lower reduction zone inlet 20 and is cycled through the lower reduction zone 16 using a second blower for circulation of the reduction gas. The second reduction gas may also be cycled using a compressor. The second reduction gas is made up of hydrogen. However it is also contemplated that the second reduction gas may include H₂, C₁, C₂, or C₃. The second reduction gas is heated to a reduction temperature before passing to the lower reduction zone 16 as the second reduction gas stream. The second reduction gas exits the reduction zone 10 through the outlet 24. The second reduction temperature is between 400° C. and 650° C., with a preferable temperature between 450° C. and 550° C. The pressure for the second reduction zone is between 2 psig to 50 psig and thermal mass ratio of the second reduction gas stream is between 0.8 and 5.

The second reduction zone 16 is operated and sized to allow for the catalyst to reside in the lower zone between 0.5 and 3 hours, with a preferred average residence time between 1 hours and 2 hours. The second reduction gas stream has no more of moisture required to reduce the chemisorbed H₂O on the catalyst by a maximum of about 75 wt % before entering the second reduction zone 16. In the example illustrated in FIG. 1, a maximum of about 75 wt % of the totally chemisorbed water on the catalyst is removed in the second reduction zone.

Another advantage of this method of catalyst reduction process is that the multiple zones may have temperature control of each inlet gas entering the individual zones. The first drying gas stream and the second reduction gas stream may include a common gas loop. For example, if the first drying gas stream and the second reduction gas stream include a common gas loop the first drying gas and second reduction gas streams may include the same temperature control, the same gas composition control, the same driers, or a mixture thereof. However, it is also contemplated that the first drying gas stream and the second reduction gas stream may have independent gas loops. For example, in this configuration the composition, temperature, and the drier system of the first drying gas stream and the second reduction gas stream may be independent.

It is also contemplated that the there may be a third reduction zone. Therefore the catalyst may be further processed and flows from the second reduction zone to the third reduction zone, where the catalyst is contacted with a third reduction gas stream for drying the residual water. The third reduction gas enters through a third reduction zone inlet and is cycled through the third reduction zone using a third blower for circulation of the drying gas. However is it also contemplated that the third reduction gas may be cycled using a compressor. The third reduction gas is made up of hydrogen. However it is also contemplated that the second reduction gas may include H₂, C₁, C₂, or C₃. The third reduction gas is heated to a reduction temperature before passing to the third reduction zone as the third reduction gas stream. The third reduction gas exits the reduction zone 10 through an outlet. The third reduction temperature is between 450° C. and 750° C., with a preferable temperature between 600° C. and 650° C. Here, where there is an additional reduction zone, a substantial amount of the chemisorbed water would be removed in the first and second zone. When there are three zones, the preferential operating conditions for the first and second zones may change. For example, if the temperature for the third zone is preferentially between 450° C. to 600° C., the temperature for the first zone may be preferably between 280° C. and 350° C., and the temperature for the second zone may be preferably between 350° C. and 450° C.

The third reduction zone is operated and sized to allow for the catalyst to reside in the lower zone between 0.5 and 3 hours, with a preferred average residence time between 1 hours and 2 hours. Preferably, the third reduction gas stream contains only enough moisture required to reduce the chemisorbed H2O on the catalyst by a maximum of 50 wt % before entering the third reduction zone.

In one example, at least about 25 wt % of the totally chemisorbed water on the catalyst is removed in the first reduction zone, at least another 25 wt % of the totally chemisorbed water on the catalyst is removed in the second reduction zone, and a maximum of about 50 wt % of the totally chemisorbed water on the catalyst is removed in the third reduction zone.

The first drying gas stream, the second reduction gas stream, and the third reduction gas stream may include a common gas loop. However, it is also contemplated that the first drying gas stream, the second reduction gas stream, and the third reduction gas stream may have independent gas loops. In this configuration the composition and the temperature of the first drying gas stream, the second reduction gas stream, and the third reduction gas stream may be controlled independently.

The third reduction gas stream flows counter-currently to the catalyst. However, it is also contemplated that the third drying gas stream may flow co-currently to the catalyst. The catalyst flows downward from through the third reduction zone using gravity. Therefore in the example where the catalyst and the third reduction gas stream flow counter-currently, the third drying gas must enter a lower gas stream inlet and exit an upper gas stream outlet. However, in the example where the catalyst and the third reduction stream flow co-currently, the third gas stream may enter at an upper inlet and exit at a lower outlet.

The dried and reduced catalyst is withdrawn through the catalyst outlet at the bottom of the reduction zone. After leaving the reduction zone, the catalyst then moves on to the reaction zone.

Any suitable catalyst may be utilized such as at least one molecular sieve including any suitable material, e.g., alumino-silicate. The catalyst can include an effective amount of the molecular sieve, which can be a zeolite with at least one pore having a 10 or higher member ring structure and can have one or higher dimension. Typically, the zeolite can have a Si/A₁₂ mole ratio of greater than 10:1, preferably 20:1 -60:1. Preferred molecular sieves can include BEA, MTW, FAU (including zeolite Y and zeolite X), EMT, FAU/EMT intergrowth, MOR, LTL, ITH, ITW, MFI, MSE, MEL, MFI/MEL intergrowth, TUN, IMF, FER, TON, MFS, IWW, EUO, MTT, HEU, CHA, ERI, MWW, AEL, AFO, ATO, and LTA. Preferably, the zeolite can be MFI, MEL, WI/MEL intergrowth, TUN, IMF, MSE and/or MTW. Suitable zeolite amounts in the catalyst may range from 1 -100%, and preferably from 10-90%, by weight.

Generally, the catalyst includes at least one metal selected from active metals, and optionally at least one metal selected from modifier metals. The total active metal content on the catalyst by weight is about less than 5% by weight. In some embodiments, the preferred total active metal content is less than about 3.0%, in yet in another embodiments the preferred total active metal content is less than 1.5%, still in yet in another embodiment the total active metal content on the catalyst by weight is less than 0.5 wt %. At least one metal is selected from IUPAC Groups that include 6,7, 8, 9, 10, and 13. The IUPAC Group 6 trough 10 includes without limitation chromium, molybdenum, tungsten, rhenium, platinum, palladium, rhodium, iridium, ruthenium and osmium, zinc, copper, and silver. The IUPAC Group 13 includes without limitation gallium, indium. In addition to at least one active metal, the catalyst may also contain at least one modifier metal selected from IUPAC Groups 11-17. The IUPAC Group 11 trough 17 includes without limitation sulfur, gold, tin, germanium, and lead.

### EXAMPLES

The following examples are intended to further illustrate the subject embodiments. These illustrations of different embodiments are not meant to limit the claims to the particular details of these examples. These examples are based on Thermo-gravimetric Analysis (TGA).

TGA includes a furnace with precise temperature control. The sample is placed on an extremely sensitive scale where a gas with a known composition is passed over the sample. The effluent gasses can be monitored by mass spectrometer for H₂O and other trace products. In addition, weight loss of the sample is monitored. TGA experiments were performed for samples that contained up to 3 wt % chemisorbed water with temperatures ranging from 280° C. to 600° C. H₂Odesorption rates were developed for the above mentioned variable ranges. Table 1 is generated using data generated from TGA studies.

TABLE 1

| Single Reduction | | Double | |
|---|---|---|---|
| Zone | | Reduction Zone | |
| Reduction Gas | 550 | Upper Reduction Zone Gas | 450 |
| Temperature, ° C. | | Temperature, ° C. | |
| Chemisorbed H₂O | 0.7 | Upper Zone Chemisorbed | 0.6 |
| Coming off | | H₂O Coming off | |
| Catalyst, wt % | | Catalyst, wt % | |
| H₂O Coming off | 0.18 | Upper Zone H₂O | 0 |
| Catalyst from | | Coming off Catalyst | |
| Reduction, wt % | | from Reduction, wt % | |
| pH2O, kPa | 0.36 | Upper Zone pH2O, kPa | 0.24 |
| | | Lower Reduction Zone Gas | 550 |
| | | Temperature, ° C. | |
| | | Lower Zone Chemisorbed | 0.1 |
| | | H₂O Coming off | |
| | | Catalyst, wt % | |
| | | Lower Zone H₂O | 0.18 |
| | | Coming off Catalyst | |
| | | from Reduction, wt % | |
| | | Lower Zone pH2O, kPa | 0.11 |

Table 1 demonstrates the benefits of having a double reduction zone design as compared to a single reduction zone design. As shown in the Table 1, preferred level of reduction necessitates high severity temperatures which inevitably desorbs a substantial amount of chemisorbed water. As a result, single reduction zone design generates high levels of H₂O at high severity conditions. The double reduction zone design alleviates this issue by dividing the reduction zone into a lower severity zone and a higher severity zone in which the upper reduction zone desorbs a significant portion of the total H₂O at low severity. Lower reduction zone operates at higher severity to reduce the catalyst to levels required by the process.

It should be noted that various changes and modifications to the presently preferred embodiments described herein will be apparent to those skilled in the art. Such changes and modifications may be made without departing from the spirit and scope of the present subject matter and without diminishing its attendant advantages.

### SPECIFIC EMBODIMENTS

While the following is described in conjunction with specific embodiments, it will be understood that this description is intended to illustrate and not limit the scope of the preceding description and the appended claims.

A first embodiment of the invention is a method of reducing a catalyst comprising feeding a zeolitic catalyst having a minimum of 0.1 wt % chemisorbed water to a first reduction zone operating at first reduction zone conditions; passing a first drying gas stream comprising drying gas to the first reduction zone, thereby generating a partially dried catalyst having at least 25% less chemisorbed water than the zeolitic catalyst; passing the partially dried catalyst to a second reduction zone operating at second reduction zone conditions that are more severe than the first reduction zone conditions; passing a second reduction gas stream comprising reduction gas to a second reduction zone, thereby generating a dry and reduced catalyst; and feeding the catalyst to a reaction zone. An embodiment of the invention is one, any or all of prior embodiments in this paragraph up through the first embodiment in this paragraph, wherein the first drying gas stream contains only enough moisture required to reduce the chemisorbed H₂O on the catalyst by between 25 wt % and 30 wt % before entering the first reduction zone. An embodiment of the invention is one, any or all of prior embodiments in this paragraph up through the first embodiment in this paragraph, wherein the first reduction zone conditions include a temperature from about 280° C. (536° F.) to about 550° C. (1022° F.). An embodiment of the invention is one, any or all of prior embodiments in this paragraph up through the first embodiment in this paragraph, wherein at least 40 wt % of the chemisorbed water on the catalyst is removed in the first reduction zone. An embodiment of the invention is one, any or all of prior embodiments in this paragraph up through the first embodiment in this paragraph, wherein the first drying gas stream flows co-currently to the catalyst. An embodiment of the invention is one, any or all of prior embodiments in this paragraph up through the first embodiment in this paragraph, wherein the first drying gas stream flows counter-currently to the catalyst. An embodiment of the invention is one, any or all of prior embodiments in this paragraph up through the first embodiment in this paragraph, wherein the first reduction zone residence times are between 0.5 hours and 3 hours. An embodiment of the invention is one, any or all of prior embodiments in this paragraph up through the first embodiment in this paragraph, wherein the second reduction zone conditions includes a temperature from about 400° C. (752° F.) to about 650° C. (1202° F.). An embodiment of the invention is one, any or all of prior embodiments in this paragraph up through the first embodiment in this paragraph, wherein the second reduction gas stream flows co-currently to the catalyst. An embodiment of the invention is one, any or all of prior embodiments in this paragraph up through the first embodiment in this paragraph, wherein the second reduction gas stream flows counter-currently with the catalyst. An embodiment of the invention is one, any or all of prior embodiments in this paragraph up through the first embodiment in this paragraph, wherein the second reduction zone residence times are between 0.5 hours and 3 hours. An embodiment of the invention is one, any or all of prior embodiments in this paragraph up through the first embodiment in this paragraph, wherein the pressure for the first reduction zone is between 2 psig to 50 psig and thermal mass ratio of the first drying gas stream is between 0.8 and 5. An embodiment of the invention is one, any or all of prior embodiments in this paragraph up through the first embodiment in this paragraph, further comprising passing a third reduction gas stream to a third reduction zone, thereby generating a dry and reduced catalyst; and feeding the dry and reduced catalyst back to the reaction zone. An embodiment of the invention is one, any or all of prior embodiments in this paragraph up through the first embodiment in this paragraph, wherein the third reduction gas stream contains only enough moisture required to reduce the chemisorbed H₂O on the catalyst by a maximum of 50 wt %. An embodiment of the invention is one, any or all of prior embodiments in this paragraph up through the first embodiment in this paragraph, wherein the third reduction zone conditions include a temperature from about 450° C. (842° F.) to about 750° C. (1382° F.). An embodiment of the invention is one, any or all of prior embodiments in this paragraph up through the first embodiment in this paragraph, wherein a maximum 50 wt % of the totally chemisorbed water on the catalyst is removed in the third reduction zone. An embodiment of the invention is one, any or all of prior embodiments in this paragraph up through the first embodiment in this paragraph, wherein the third reduction gas stream flows co-currently to the catalyst. An embodiment of the invention is one, any or all of prior embodiments in this paragraph up through the first embodiment in this paragraph, wherein the third reduction gas stream flows counter-currently with the catalyst. An embodiment of the invention is one, any or all of prior embodiments in this paragraph up through the first embodiment in this paragraph, wherein the third reduction zone residence times are between 0.5 hours and 3 hours. An embodiment of the invention is one, any or all of prior embodiments in this paragraph up through the first embodiment in this paragraph, wherein the third reduction zone conditions include a temperature from about 450° C. to 600° C., the first reduction zone conditions include a temperature from about 280° C. to 350° C., and the second reduction zone conditions include a temperature from about 350° C. to 450° C. An embodiment of the invention is one, any or all of prior embodiments in this paragraph up through the first embodiment in this paragraph, wherein the pressure for the second reduction zone is between 2 psig to 50 psig and thermal mass ratio of the second reduction gas stream is between 0.8 and 5.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A method of reducing a catalyst comprising:
feeding a zeolitic catalyst having a minimum of 0.1 wt % chemisorbed water to a first reduction zone operating at first reduction zone conditions;
passing a first drying gas stream comprising drying gas to the first reduction zone, thereby generating a partially dried catalyst having at least 25% less chemisorbed water than the zeolitic catalyst;
passing the partially dried catalyst to a second reduction zone operating at second reduction zone conditions that are more severe than the first reduction zone conditions;
passing a second reduction gas stream comprising reduction gas to a second reduction zone, thereby generating a dry and reduced catalyst; and
feeding the catalyst to a reaction zone.

2. The method of claim 1, wherein the first drying gas stream contains only enough moisture required to reduce the chemisorbed H₂O on the catalyst by between 25 wt % and 30 wt % before entering the first reduction zone.

3. The method of claim 1, wherein the first reduction zone conditions include a temperature from about 280° C. (536° F.) to about 550° C. (1022° F.).

4. The method of claim 1, wherein at least 40 wt % of the chemisorbed water on the catalyst is removed in the first reduction zone.

5. The method of claim 1, wherein the first drying gas stream flows co-currently to the catalyst.

6. The method of claim 1, wherein the first drying gas stream flows counter-currently to the catalyst.

7. The method of claim 1, wherein the first reduction zone residence times are between 0.5 hours and 3 hours.

8. The method of claim 1, wherein the second reduction zone conditions includes a temperature from about 400° C. (752° F.) to about 650° C. (1202° F.).

9. The method of claim 1, wherein the second reduction gas stream flows co-currently to the catalyst.

10. The method of claim 1, wherein the second reduction gas stream flows counter-currently with the catalyst.

11. The method of claim 1, wherein the second reduction zone residence times are between 0.5 hours and 3 hours.

12. The method of claim 1, wherein the pressure for the first reduction zone is between 2 psig to 50 psig and thermal mass ratio of the first drying gas stream is between 0.8 and 5.

13. The method of claim 1, further comprising passing a third reduction gas stream to a third reduction zone, thereby generating a further dry and reduced catalyst; and feeding the dry and reduced catalyst back to the reaction zone.

14. The method of claim 13, wherein the third reduction gas stream contains only enough moisture required to reduce the chemisorbed H₂O on the catalyst by a maximum of 50 wt %.

15. The method of claim 13, wherein the third reduction zone conditions include a temperature from about 450° C. (842° F.) to about 750° C. (1382° F.).

16. The method of claim 13, wherein a maximum 50 wt % of the totally chemisorbed water on the catalyst is removed in the third reduction zone.

17. The method of claim 13, wherein the third reduction gas stream flows co-currently to the catalyst.

18. The method of claim 13, wherein the third reduction gas stream flows counter-currently with the catalyst.

19. The method of claim 13, wherein the third reduction zone residence times are between 0.5 hours and 3 hours.

20. The method of claim 13, wherein the third reduction zone conditions include a temperature from about 450° C. to 600° C., the first reduction zone conditions include a temperature from about 280° C. to 350° C., and the second reduction zone conditions include a temperature from about 350° C. to 450° C.

21. The method of claim 1, wherein the pressure for the second reduction zone is between 2 psig to 50 psig and thermal mass ratio of the second reduction gas stream is between 0.8 and 5.
